(19) United States
(12) Patent Application Publication
(10) Pub. No.: US 2017/0149934 A1
(43) Pub. Date: May 25, 2017

(54) METHOD, DEVICE AND SYSTEM FOR DATA CROSS-DOMAIN REQUEST

(71) Applicants: Le Holdings (Beijing) Co., Ltd., Beijing (CN); LETV SPORTS CULTURE DEVELOP(BEIJING) CO., LTD., Beijing (CN)

(72) Inventors: Fei LU, Beijing (CN); Ranyang WANG, Beijing (CN)

(21) Appl. No.: 15/245,207

(22) Filed: Aug. 24, 2016

Related U.S. Application Data
(63) Continuation of application No. PCT/CN2016/082631, filed on May 19, 2016.

(30) Foreign Application Priority Data
Nov. 24, 2015 (CN) 201510828991.7

(51) Int. Cl. H04L 29/06; G06F 21/10; H04L 29/08

(52) U.S. Cl. CPC H04L 67/42; H04L 67/02; H04L 67/146; G06F 21/10

(57) ABSTRACT

Disclosed are a method, a device and a system for data cross-domain request. The method includes: receiving a first data cross-domain request sent by a client, wherein the first data cross-domain request carries a uniform resource locator (URL) and identification information of a second data cross-domain request, the first data cross-domain request is a data cross-domain request supported in a JavaScript object notation with padding (JSONP) manner, and the second data cross-domain request is a data cross-domain request not supported in the JSONP manner; and processing data corresponding to the URL according to the second data cross-domain request and sending a processing result to the client when the identification information of the second data cross-domain request is matched with the identification information of the preset data cross-domain request.

### CROSS-REFERENCE TO RELATED APPLICATIONS

This application is a continuation of International Application No. PCT/CN2016/082631, filed on May 19, 2016, which is based upon and claims priority to Chinese Patent Application No. 201510828991.7, filed on Nov. 24, 2015, the entire contents of which are incorporated herein by reference.

### TECHNICAL FIELD

The present disclosure relates to information technologies, and more particularly, to a method, a device and a system for data cross-domain request.

### BACKGROUND

With constant development of Internet technologies, Asynchronous JavaScript And XML (AJAX) is widely used. However, the core of AJAX is a JavaScript (an interpreted scripting language) object, which is a technology supporting an asynchronous request. A user may use JavaScript to make a request to a server and get a response without affecting use of other users. However, in practical application, AJAX implements data interaction by means of the JavaScript object. When a user needs to access page contents of other domains, in view of security, a browser does not allow a JS code to perform a cross-domain operation, where the JS code is a code of a script file compiled by using a scripting language JavaScript, and any one of a protocol, a domain name and a port of the uniform resource locator (URL) of a cross-domain request is different from a URL of a current page. At present, to solve the foregoing problem, a cross-domain request may be performed by adopting JavaScript object notation with padding (JSONP), JavaScript files of other domains are loaded and executed by using a script tag of a hyper text mark-up language (HTML), where JSONP is a usage pattern for data interchange between a browser and a server. However, using JSONP can only implement a GET request and is unable to implement a POST cross-domain request, a PUT cross-domain request and a DELETE cross-domain request or the like.

At present, to implement the POST cross-domain request, the PUT cross-domain request and the DELETE cross-domain request or the like, a cross-domain request may be performed by adopting a way of agency, for example, a Flash agent cross-domain request or a server agent cross-domain request. However, when a cross-domain request is performed by adopting a way of agency, it is required that the Flash or the server forwards a data cross-domain request to a cross-domain server and the Flash or the server forwards data responded by the cross-domain server to a client, which causes cumbersome operation of a data cross-domain request, thereby causing a lower efficiency of the data cross-domain request.

### SUMMARY

The present disclosure provides a method, a device and a system for data cross-domain request, which are intended to solve a defect of lower efficiency of a data cross-domain request.

In a first aspect, embodiments of the present disclosure provide a method for data cross-domain request, implemented by a server, including:

receiving a first data cross-domain request sent by a client, the first data cross-domain request carrying a URL and identification information of a second data cross-domain request, the first data cross-domain request being a data cross-domain request supported in a JSONP manner, and the second data cross-domain request being a data cross-domain request not supported in the JSONP manner;

detecting whether the identification information of the second data cross-domain request is matched with identification information of a preset data cross-domain request, a server saving identification information of multiple preset data cross-domain requests; and

processing data corresponding to the URL according to the second data cross-domain request and sending a processing result to the client when the identification information of the second data cross-domain request is matched with the identification information of the preset data cross-domain request.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for data cross-domain request mentioned by embodiments of the present disclosure.

In a third aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to:

obtain a first data cross-domain request and identification information of a second data cross-domain request, the first data cross-domain request carrying a uniform resource locator URL, the first data cross-domain request being a data cross-domain request supported in a JSONP manner, and the second data cross-domain request being a data cross-domain request not supported in the JSONP manner;

configure the identification information in the first data cross-domain request;

send the first data cross-domain request configured with the identification information to a server so that the server processes data corresponding to a URL according to the second data cross-domain request; and

receive a processing result sent by the server.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for data cross-domain request in accordance with some embodiments;

FIG. 2 is a flowchart of another method for data cross-domain request in accordance with some embodiments;

FIG. 3 is a schematic structural diagram of a server in accordance with some embodiments;

FIG. 4 is a schematic structural diagram of a client in accordance with some embodiments;

FIG. 5 is a system for data cross-domain request in accordance with some embodiments;

FIG. 6 is a schematic diagram of an entity structure of a server in accordance with some embodiments; and

FIG. 7 is a block diagram of an electronic device in accordance with some embodiments.

### DETAILED DESCRIPTION

In order to make objectives, technical solutions and advantages of embodiments of the present disclosure more clear, technical solutions in embodiments of the present disclosure will be described clearly and completely with reference to drawings of embodiments of the present disclosure. It should be noted that the following embodiments are illustrative only, rather than limiting the scope of the disclosure.

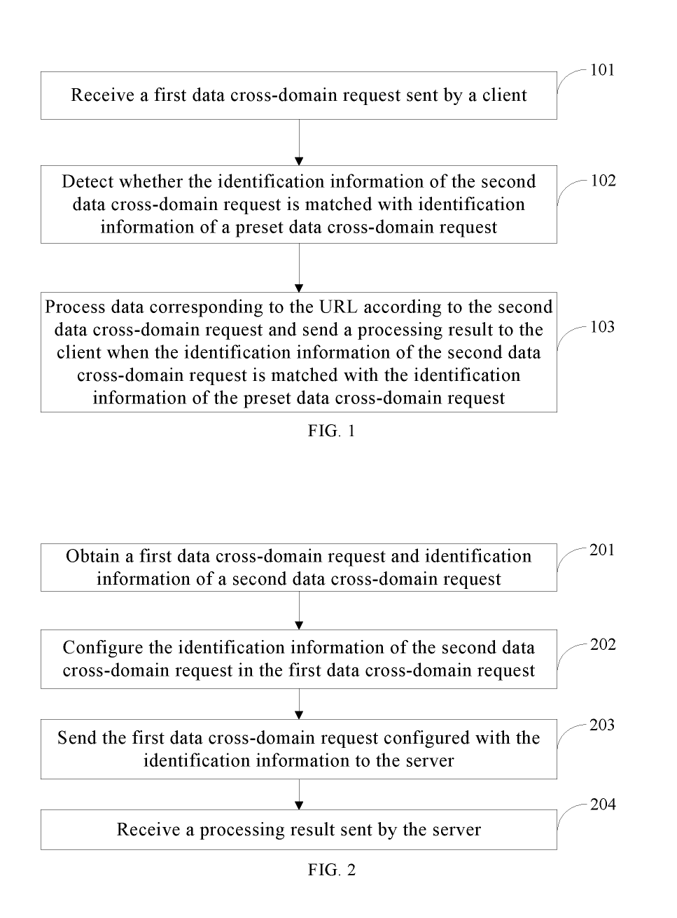

Embodiments of the present disclosure provide a method for data cross-domain request, which may be applied to a server, as shown in FIG. 1, the method includes:

101: The server receives a first data cross-domain request sent by a client.

The first data cross-domain request carries a uniform resource locator (URL) and identification information of a second data cross-domain request, the first data cross-domain request is a data cross-domain request supported in a JSONP manner, for example, a GET request. The second data cross-domain request is a data cross-domain request not supported in the JSONP manner. The client can be a browser. The identification information of the second data cross-domain request can be a name of the second data cross-domain request, for example, a POST cross-domain request, a PUT cross-domain request, a DELETE cross-domain request or the like, or can be an identity (ID) of the second data cross-domain request, which is not limited in the embodiments of the present disclosure.

It should be explained that the server can customize a data cross-domain request specification in advance so that the client can send a data cross-domain request according to the customized data cross-domain request specification, namely, the client only needs to add the identification information of the second data cross-domain request into the first data cross-domain request so as to implement the second data cross-domain request such as a POST request, which avoids cumbersome operation for performing the second data cross-domain request by proxy, and ensures the client to get quick response to the second data cross-domain request, thereby improving efficiency of a data cross-domain request.

For example, a data cross-domain request actually needed to be sent by the client is a POST cross-domain request, and a requested URL is:

http://api.lesports.com/sms/v1/match;

The client can send a GET request to the server in advance according to the specification customized by the server, then add POST into the GET request, and a requested URL still is:

http://api.lesports.com/sms/v1/match.

When the server detects that a POST is carried in the GET request sent by the client, it is determined that the POST is a data cross-domain request actually needed to be initiated.

102: The server detects whether the identification information of the second data cross-domain request is matched with identification information of a preset data cross-domain request.

Identification information of multiple preset data cross-domain requests is saved in the server. When the server provides a processing strategy of a request, the identification information of the preset data cross-domain request can be configured according to the processing strategy of the request, and also the configured identification information of the preset data cross-domain request is saved. For example, if a processing strategy of a POST request is saved in the server, the POST can be configured to be the identification information of the preset data cross-domain request. When the identification information of the second data cross-domain request sent by the client is a POST, it is determined that the identification information of the second data cross-domain request is matched with identification information of a preset data cross-domain request.

It should be explained that a saving form corresponding to the identification information of the preset data cross-domain request can be a key-value pair, a key in the key-value pair is configured to identify that the first data cross-domain request sent by the client is overloadable, namely, the first data cross-domain request currently sent by the client is not a cross-domain request that is really needed to be initiated, and a value is the identification information of the preset data cross-domain request.

For example, the key-value pair is X-HTTP-Method-Override: POST, where the key in the key-value pair is X-HTTP-Method-Override, and the value of the key-value pair is POST. At the moment, this indicates that the POST cross-domain request is a cross-domain request that is actually needed to be initiated by the client.

In the embodiments of the present disclosure, Step 102 specifically may include: detecting whether the value of the key-value pair is matched with a value of a preset key-value pair.

103: The server processes data corresponding to the URL according to the second data cross-domain request and sends a processing result to the client when the identification information of the second data cross-domain request is matched with the identification information of the preset data cross-domain request.

In the embodiments of the present disclosure, when the second data cross-domain request is a POST request, the processing data corresponding to the URL according to the second data cross-domain request specifically can include: modifying data corresponding to the URL and sending the modified data to the client. When the second data cross-domain request is a PUT request, the processing data corresponding to the URL according to the second data cross-domain request and sending a processing result to the client specifically can include: adding data corresponding to the URL and sending an added result to the client. When the second data cross-domain request is a DELETE request, the processing data corresponding to the URL according to the second data cross-domain request and sending a processing result to the client specifically can include: deleting data corresponding to the URL and sending a deleted result to the client.

Embodiments of the present disclosure provide a method for data cross-domain request, by configuring the identification information of the second data cross-domain request in the first data cross-domain request, it is changed that in the prior art a POST cross-domain request, a PUT cross-domain request and a DELETE cross-domain request or the like need to adopt a way of agency, the POST cross-domain request, the PUT cross-domain request and the DELETE cross-domain request or the like can be directly implemented, thereby improving the efficiency of a data cross-domain request.

Embodiments of the present disclosure provide another method for data cross-domain request, which can be applied to a client, as shown in FIG. 2, the method includes:

201: The client obtains the first data cross-domain request and identification information of the second data cross-domain request.

The first data cross-domain request carries a uniform resource locator (URL), the first data cross-domain request is a data cross-domain request supported in a JSONP manner, and the second data cross-domain request is a data cross-domain request not supported in the JSONP manner.

202: The client configures the identification information of the second data cross-domain request in the first data cross-domain request.

In the embodiments of the present disclosure, the client directly adds the identification information of the second data cross-domain request into the first data cross-domain request, the identification information of the second data cross-domain request is transmitted to the server by the first data cross-domain request supported by way of JSONP, in this way, it is implemented the second data cross-domain request that is actually needed to be sent by the client, it is avoided cumbersome operation for performing the second data cross-domain request by proxy, and it is ensured that the client gets quick response to the second data cross-domain request, thereby improving efficiency of a data cross-domain request.

In the embodiments of the present disclosure, Step 202 specifically can include: adding the identification information of the second data cross-domain request into a field corresponding to the first data cross-domain request.

The field corresponding to the first data cross-domain request can be: X-HTTP-Method-Override. By setting up a requested field in the first data cross-domain request, it can be identified that the first data cross-domain request currently sent by the client is not a cross-domain request that is really needed to be initiated; and by adding the identification information of the second data cross-domain request into the field corresponding to the first data cross-domain request, it can be identified a request mode that is actually needed to be initiated.

203: The client sends the first data cross-domain request configured with identification information to the server.

Further, it is convenient for the server to process data corresponding to the URL according to the second data cross-domain request.

204: The client receives a processing result sent by the server.

In the embodiments of the present disclosure, Step 204 specifically can include: receiving the modified data sent by the server, where the modified data are data obtained by modifying data corresponding to the URL by the server according to the modified POST request.

In the embodiments of the present disclosure, Step 204 also can specifically include: receiving an added result sent by the server, where the added result is a result generated by the server by adding data corresponding to the URL according to a PUT request.

In the embodiments of the present disclosure, Step 204 also can specifically include: receiving a deleted result sent by the server, where the deleted result is a result generated by the server by deleting data corresponding to the URL according to a DELETE request.

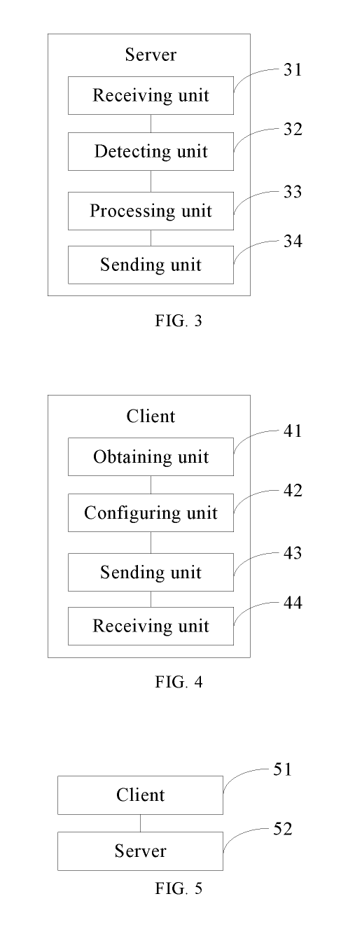

Further, as a concrete implementation of the method as shown in FIG. 1, embodiments of the present disclosure provide a server, as shown in FIG. 3, the server includes: a receiving unit 31, a detecting unit 32, a processing unit 33 and a sending unit 34.

The receiving unit 31 is configured to receive a first data cross-domain request sent by a client, where the first data cross-domain request carries a uniform resource locator (URL) and identification information of a second data cross-domain request, the first data cross-domain request is a data cross-domain request supported in a JSONP manner, and the second data cross-domain request is a data cross-domain request not supported in the JSONP manner. The first data cross-domain request is a GET request, and the second data cross-domain request is any one of a POST request, a PUT request and a DELETE request. The receiving unit 31 is a main functional module in the server for receiving the first data cross-domain request.

The detecting unit 32 is configured to detect whether the identification information of the second data cross-domain request is matched with identification information of a preset data cross-domain request, and identification information of different preset data cross-domain requests is saved in the server. The detecting unit 32 is a main functional module in the server for detecting whether the identification information of the second data cross-domain request is matched with identification information of a preset data cross-domain request.

The processing unit 33 is configured to process data corresponding to the URL according to the second data cross-domain request when the identification information of the second data cross-domain request is matched with the identification information of the preset data cross-domain request. The processing unit 33 is a main functional module in the server for processing data corresponding to the URL according to the second data cross-domain request.

The sending unit 34 is configured to send a processing result to the client. The sending unit 34 is a main functional module in the server for sending a processing result.

A saving form corresponding to the identification information of the preset data cross-domain request is a key-value pair, a key in the key-value pair is configured to identify that the first data cross-domain request sent by the client is overloadable, and a value is the identification information of the preset data cross-domain request.

The detecting unit 32 is specifically configured to detect whether the value of the key-value pair is matched with a value of a preset key-value pair.

It should be explained that reference may be made to corresponding description of the method as shown in FIG. 1 for other corresponding description of various functional units involved with the server provided by the embodiments of the present disclosure, which is not repeated any more herein. In the embodiments of the present disclosure, relevant functional modules can be implemented by means of a hardware processor.

In a server provided by embodiments of the present disclosure, by configuring the identification information of the second data cross-domain request in the first data cross-domain request, it is changed that in the prior art a POST cross-domain request, a PUT cross-domain request and a DELETE cross-domain request or the like need to adopt a way of agency, the POST cross-domain request, the PUT cross-domain request and the DELETE cross-domain request or the like can be directly implemented, thereby improving the efficiency of a data cross-domain request.

Further, as a concrete implementation of the method as shown in FIG. 2, embodiments of the present disclosure provide a client, as shown in FIG. 4, the client includes: an obtaining unit 41, a configuring unit 42, a sending unit 43 and a receiving unit 44.

The obtaining unit 41 is configured to obtain a first data cross-domain request and identification information of a second data cross-domain request, where the first data cross-domain request carries a uniform resource locator (URL), the first data cross-domain request is a data cross-domain request supported in a JSONP manner, and the second data cross-domain request is a data cross-domain request not supported in the JSONP manner. The first data cross-domain request is a GET request, and the second data cross-domain request is any one of a POST request, a PUT request and a DELETE request. The obtaining unit 41 is a main functional module in the client for obtaining the first data cross-domain request and identification information of the second data cross-domain request.

The configuring unit 42 is configured to configure the identification information in the first data cross-domain request. The configuring unit 42 is a main functional module in the client for configuring the identification information in the first data cross-domain request.

The sending unit 43 is configured to send the first data cross-domain request configured with the identification information to the server.

Further, it is convenient for the server to process data corresponding to a URL according to the second data cross-domain request. The sending unit 43 is a main functional module in the client for sending the first data cross-domain request.

The receiving unit 44 is configured to receive a processing result sent by the server. The receiving unit 74 is a main functional module in the client for receiving a processing result.

It should be explained that reference may be made to corresponding description of the method as shown in FIG. 4 for other corresponding description of various functional units involved with the client provided by the embodiments of the present disclosure, which is not repeated any more herein. In the embodiments of the present disclosure, relevant functional modules can be implemented by means of a hardware processor.

The configuring unit 42 is configured to add the identification information into a field corresponding to the first data cross-domain request.

Embodiments of the present disclosure provide a client, by configuring the identification information of the second data cross-domain request in the first data cross-domain request, it is changed that in the prior art a POST cross-domain request, a PUT cross-domain request and a DELETE cross-domain request or the like need to adopt a way of agency, the POST cross-domain request, the PUT cross-domain request and the DELETE cross-domain request or the like can be directly implemented, thereby improving the efficiency of a data cross-domain request.

It should be explained that reference may be made to corresponding description of the method as shown in FIG. 2 for other corresponding description of various functional units involved with the client provided by the embodiments of the present disclosure, which is not repeated any more herein. In the embodiments of the present disclosure, relevant functional modules can be implemented by means of a hardware processor.

Embodiments of the present disclosure provide a client, by configuring the identification information of the second data cross-domain request in the first data cross-domain request, it is changed that in the prior art a POST cross-domain request, a PUT cross-domain request and a DELETE cross-domain request or the like need to adopt a way of agency, the POST cross-domain request, the PUT cross-domain request and the DELETE cross-domain request or the like can be directly implemented, thereby improving the efficiency of a data cross-domain request.

Embodiments of the present disclosure provide a system for data cross-domain request, including: client 51 and a server 52.

The client 51 is configured to: obtain a first data cross-domain request and identification information of a second data cross-domain request, where the first data cross-domain request carries a uniform resource locator (URL); configure the identification information in the first data cross-domain request; and send the first data cross-domain request configured with the identification information to the server 52.

The server 52 is configured to: detect whether the identification information of the second data cross-domain request is matched with identification information of a preset data cross-domain request, where identification information of different preset data cross-domain requests is saved in the server; and process data corresponding to the URL according to the second data cross-domain request and send a processing result to the client 51 when the identification information of the second data cross-domain request is matched with the identification information of the preset data cross-domain request.

It should be explained that in allusion to the foregoing client, the server and the system for data cross-domain request, functions of each unit module used in the embodiment of the present disclosure may be implemented through a hardware processor.

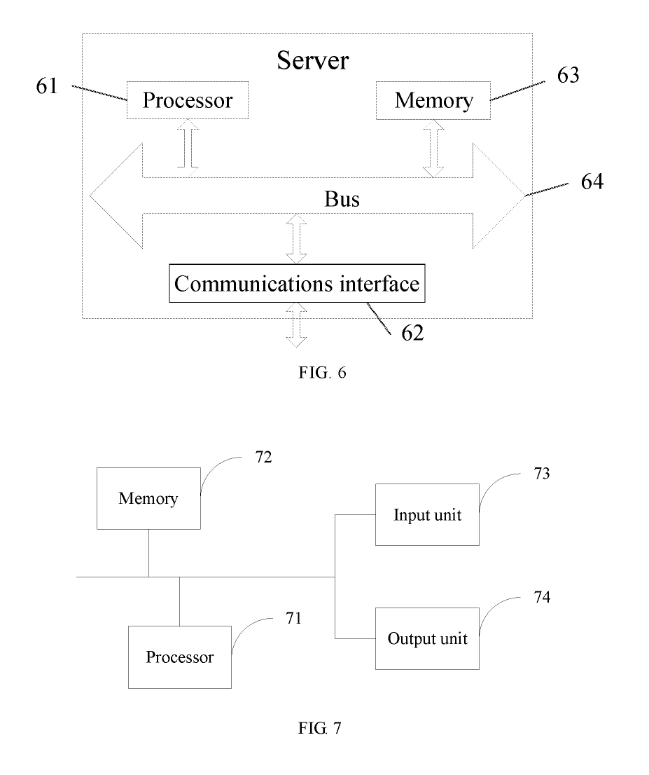

Exemplarily, as shown in FIG. 6, which shows a schematic diagram of an entity structure of a server according to embodiments of the present disclosure, the server can include: a processor 61, a communications interface 62, a memory 63 and a bus 64, where the processor 61, the communications interface 62 and the memory 63 complete communications among each other through the bus 64. The communications interface 62 can be configured to implement information transmission between the server and the client. The processor 61 can invoke a logic instruction in the memory 63 to execute the following method: receiving a first data cross-domain request sent by the client, where the first data cross-domain request carries a uniform resource locator (URL) and identification information of a second data cross-domain request, the first data cross-domain request is a data cross-domain request supported in a JSONP manner, and the second data cross-domain request is a data cross-domain request not supported in the JSONP manner; detecting whether the identification information of the second data cross-domain request is matched with identification information of a preset data cross-domain request, where identification information of multiple preset data cross-domain requests is saved in the server; and processing data corresponding to the URL according to the second data cross-domain request and sending a processing result to the client when the identification information of the second data cross-domain request is matched with the identification information of the preset data cross-domain request.

In addition, when a logic instruction in the foregoing memory 63 can be implemented in the form of a software functional unit and is sold or used as an independent product, the logic instruction can be stored in a computer-readable storage medium. Based on such an understanding, the technical solution of the present disclosure in essence or that part of contribution to the prior art or a part of the technical solution may be embodied in the form of software products, which may be stored in a storage medium, comprising some instructions to cause a computer device (a personal computer, a server or a network device and so on) to execute all or a part of steps of the method as recited in the embodiments of the present disclosure. The aforementioned storage medium includes: a USB flash disk, a read-only memory (ROM), a random access memory (RAM), a magnetic disk or an optical disk and other media capable of storing a program code.

Embodiments of the present disclosure provide a system for data cross-domain request, by configuring the identification information of the second data cross-domain request in the first data cross-domain request, it is changed that in the prior art a POST cross-domain request, a PUT cross-domain request and a DELETE cross-domain request or the like need to adopt a way of agency, the POST cross-domain request, the PUT cross-domain request and the DELETE cross-domain request or the like can be directly implemented, thereby improving the efficiency of a data cross-domain request.

Further, an embodiment of the present disclosure further provides a non-transitory computer-readable storage medium storing executable instructions, which can be executed by an electronic device to perform any methods for data cross-domain request mentioned by embodiments of the present disclosure.

FIG. 7 is a block diagram of an electronic device which is configured to perform the methods for data cross-domain request according to an embodiment of the present disclosure. As shown in FIG. 7, the device includes: one or more processors 71 and memory 72. A processor 71 is showed in FIG. 7 for an example.

Device which is configured to perform the methods for data cross-domain request can also include: input unit 73 and output unit 74.

Processor 71, memory 72, input unit 73 and output unit 74 can be connected by BUS or other methods, and BUS connecting is showed in FIG. 7 for an example.

Memory 72 can be used for storing non-transitory software program, non-transitory computer executable program and modules as a non-transitory computer-readable storage medium, such as corresponding program instructions/modules for the methods for data cross-domain request mentioned by embodiments of the present disclosure (such as shown in FIG. 3, receiving unit 31, detecting unit 32, processing unit 33 and sending unit 34). Processor 71 performs kinds of functions and data cross-domain request of the electronic device by executing non-transitory software program, instructions and modules which are stored in memory 72, thereby realizes the methods for data cross-domain request mentioned by embodiments of the present disclosure.

Memory 72 can include program storage area and data storage area, thereby the operating system and applications required by at least one function can be stored in program storage area and data created by using the device for data cross-domain request can be stored in data storage area. Furthermore, memory 72 can include high speed Random-access memory (RAM) or non-volatile memory such as magnetic disk storage device, flash memory device or other non-volatile solid state storage devices. In some embodiments, memory 72 can include long-distance setup memories relative to processor 71, which can communicate with the device for data cross-domain request by networks. The examples of said networks are including but not limited to Internet, Intranet, LAN, mobile Internet and their combinations.

Input unit 73 can be used to receive inputted number, character information and key signals causing user configures and function controls of the device for data cross-domain request. Output unit 74 can include a display screen or a display device.

The said module or modules are stored in memory 72 and perform the methods for data cross-domain request when executed by one or more processors 71.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The apparatus embodiments set forth above are merely exemplary, where units described as detached parts can be or not be detachable physically; parts displayed as units can be or not be physical units, i.e., either located at the same place, or distributed on a plurality of network units. Modules may be selected in part or in whole according to actual needs for achieving objectives of the solution of this embodiment.

It can be known from the foregoing implementation modes, those skilled in the art may clearly know that various implementation modes can be implemented by feat of software and necessary general hardware platform, or of course by means of hardware. Based on such an understanding, the foregoing technical solutions in essence or that part of contribution to the prior art may be embodied in the form of software products, which may be stored in computer-readable storage media, such as ROM/RAM, diskettes or optical disks and the like, including some instructions so that it is possible to execute embodiments or methods as recited in some parts of embodiments by a computer equipment (a personal computer, or a server, or network equipment, etc.).

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the spirit or scope of the technical solutions of the embodiments of the present disclosure.

What is claimed is:

1. A method for data cross-domain request, implemented by a server, comprising:
receiving a first data cross-domain request sent by a client, the first data cross-domain request carrying a uniform resource locator (URL) and identification information of a second data cross-domain request, the first data cross-domain request being a data cross-domain request supported in a JavaScript object notation with padding (JSONP) manner, and the second data cross-domain request being a data cross-domain request not supported in the JSONP manner;
detecting whether the identification information of the second data cross-domain request is matched with identification information of a preset data cross-domain request, a server saving identification information of multiple preset data cross-domain requests; and
processing data corresponding to the URL according to the second data cross-domain request and sending a processing result to the client when the identification information of the second data cross-domain request is matched with the identification information of the preset data cross-domain request.

2. The method for data cross-domain request according to claim 1, wherein a saving form corresponding to the identification information of the preset data cross-domain request is a key-value pair, a key in the key-value pair is configured to identify that the first data cross-domain request sent by the client is overloadable, a value is the identification information of the preset data cross-domain request; and
detecting whether the identification information of the second data cross-domain request is matched with identification information of a preset data cross-domain request comprises:
detecting whether the value of the key-value pair is matched with a value of a preset key-value pair.

3. The method for data cross-domain request according to claim 1, wherein the first data cross-domain request is a GET request, and the second data cross-domain request is any one of a POST request, a PUT request and a DELETE request.

4. An electronic device, comprising:
at least one processor; and
a memory communicably connected with the at least one processor for storing instructions executable by the at least one processor, wherein execution of the instructions by the at least one processor causes the at least one processor to:
receive a first data cross-domain request sent by a client, the first data cross-domain request carrying a URL and identification information of a second data cross-domain request, the first data cross-domain request being a data cross-domain request supported in a JSONP manner, and the second data cross-domain request being a data cross-domain request not supported in the JSONP manner;
detect whether the identification information of the second data cross-domain request is matched with identification information of a preset data cross-domain request, a server saving identification information of multiple preset data cross-domain requests; and
process data corresponding to the URL according to the second data cross-domain request and send a processing result to the client when the identification information of the second data cross-domain request is matched with the identification information of the preset data cross-domain request.

5. The electronic device according to claim 4, wherein a saving form corresponding to the identification information of the preset data cross-domain request is a key-value pair, a key in the key-value pair is configured to identify that the first data cross-domain request sent by the client is overloadable, a value is the identification information of the preset data cross-domain request; and
detecting whether the identification information of the second data cross-domain request is matched with identification information of a preset data cross-domain request comprises:
detecting whether the value of the key-value pair is matched with a value of a preset key-value pair.

6. The electronic device according to claim 4, wherein the first data cross-domain request is a GET request, and the second data cross-domain request is any one of a POST request, a PUT request and a DELETE request.

7. An electronic device, comprising:
at least one processor; and
a memory communicably connected with the at least one processor for storing instructions executable by the at least one processor, wherein execution of the instructions by the at least one processor causes the at least one processor to:
obtain a first data cross-domain request and identification information of a second data cross-domain request, the first data cross-domain request carrying a uniform resource locator URL, the first data cross-domain request being a data cross-domain request supported in a JSONP manner, and the second data cross-domain request being a data cross-domain request not supported in the JSONP manner;
configure the identification information in the first data cross-domain request;
send the first data cross-domain request configured with the identification information to a server so that the server processes data corresponding to a URL according to the second data cross-domain request; and
receive a processing result sent by the server.

8. The electronic device according to claim 7, wherein configuring the identification information in the first data cross-domain request comprises:
adding the identification information into a field corresponding to the first data cross-domain request.

9. The electronic device according to claim 7, wherein the first data cross-domain request is a GET request, and the second data cross-domain request is any one of a POST request, a PUT request and a DELETE request.
